(19) United States
(12) Patent Application Publication
(10) Pub. No.: US 2015/0062130 A1
(43) Pub. Date: Mar. 5, 2015

(54) LOW POWER DESIGN FOR AUTONOMOUS ANIMATION

(71) Applicant: BlackBerry Limited, Waterloo (CA)

(72) Inventor: Christopher Ying Wai Ho, Markham (CA)

(73) Assignee: BlackBerry Limited, Waterloo (CA)

(21) Appl. No.: 14/015,055

(22) Filed: Aug. 30, 2013

(51) Int. Cl. G06T 13/00

(52) U.S. Cl. CPC G06T 13/00
USPC 345/473

(57) ABSTRACT

Devices, methods, and non-transitory media for controlling a microdisplay are described. A device includes a microdisplay; and a display controller for the microdisplay. The display controller includes at least one frame buffer configured to store a multi-frame animation; and control logic configured to control operation of the microdisplay in response to signals generated by a host controller of the mobile electronic device, the control logic comprising executable instructions to display the animation on the microdisplay by: commencing display of the animation when signals representing a start command generated by the host controller are detected, and repeatedly displaying the animation in the absence of detecting further signals representing commands generated by the host controller.

### FIELD OF THE DISCLOSURE

This application relates to the field of mobile electronic devices, and more particularly, to mobile electronic devices having display devices.

### BACKGROUND

With the increasing use of mobile devices, information is commonly communicated to users via a display device or auditory signal. In situations where illuminating a large display or emitting a sound are not appropriate, a light-emitting diode (LED) may be used. However, in some situations, an LED may only provide limited information.

### SUMMARY

In accordance with an aspect of the present invention there is provided an electronic device including a microdisplay; and a display controller for the microdisplay. The display controller includes: at least one frame buffer configured to store a multi-frame animation; and control logic configured to control operation of the microdisplay in response to signals generated by a host controller of the mobile electronic device. The control logic includes executable instructions to display the animation on the microdisplay by: commencing display of the animation when signals representing a start command generated by the host controller are detected, and repeatedly displaying the animation in the absence of detecting further signals representing commands generated by the host controller.

In accordance with another aspect of the present invention there is provided a computer readable medium persistently storing control logic configured to control operation of a microdisplay of a mobile electronic device in response to commands from a host controller of the mobile electronic device. The control logic includes executable instructions to display a multi-frame animation on the microdisplay by: commencing display of the animation when signals representing a start command generated by the host controller are detected, and repeatedly displaying the animation in the absence of detecting further signals representing commands generated by the host controller.

In accordance with another aspect of the present invention there is provided a display controller for a microdisplay of an electronic device. The display controller includes: at least one frame buffer configured to store a multi-frame animation; and control logic configured to control operation of the microdisplay in response to signals generated by a host controller of the electronic device. The control logic includes executable instructions to display the animation on the microdisplay by: commencing display of the animation when signals representing a start command generated by the host controller are detected, and repeatedly displaying the animation in the absence of detecting further signals representing commands generated by the host controller.

### DESCRIPTION OF DRAWINGS

Examples of various aspects and embodiments of the invention are shown in the drawings, and described therein and elsewhere throughout the disclosure. In the drawings, like references indicate like parts.

FIG. 1 is an front elevation view of an example device in accordance with various aspects of the disclosure.

FIGS. 2 and 3 are schematic diagrams of example devices in accordance with various aspects of the disclosure.

FIG. 4 is an example flow diagram in accordance with aspects of the disclosure.

### DETAILED DESCRIPTION

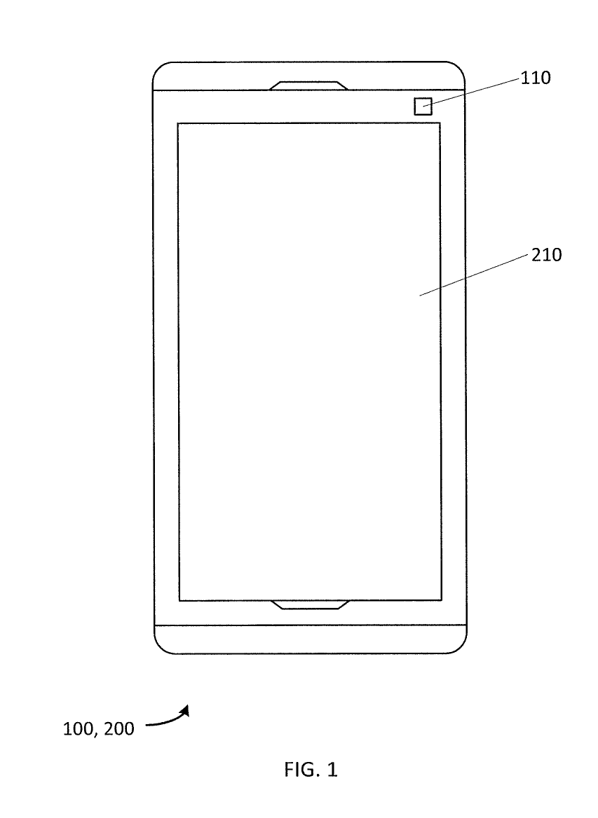

Small displays such as microdisplays can provide information to a user or observer. FIG. 1 shows an example electronic device 100, 200 in the form of a smartphone or other wireless handheld or mobile device having a small display 110. In some examples, the electronic device 100, 200 can be a mobile electronic device such as a mobile phone, pager, personal media player, mobile computer, tablet computer, camera, remote control device, GPS (global positioning system) device. The electronic device 100, 200 can, in other examples, be any other suitable electronic device such as a desktop computer, monitor, television, audio or video device, corded or coreless telephone, printer, computer peripheral, video gaming device, networking device, storage device, and the like.

As illustrated in FIG. 1, the example electronic device 100, 200 can include a small display 110 in addition to a primary display 210. In other examples, the small display 110 may be the only display on the device 100, 200. While the small display 110 is shown on the front face of the device 100, 200 in FIG. 1, in other examples, the small display 110 may be positioned in any position or orientation on the device suitable for its viewing purpose.

When a small display having a small viewing area and/or low resolution is used, the amount of information which can be conveyed on the display may be limited. To convey more information, in some example scenarios, an animation or moving or sequential images can be displayed on the small display 110.

Commonly, to display an animation on a display, a host processor can continuously provide frames of images to the display to display as a video or sequence of images. This process can, in some examples, place a burden on the host processor which may be managing numerous tasks or devices/components of the electronic device 100, 200. In such examples, displaying an animation on the display can require frequent and timely processing and power consumption by the host processor. In some examples, different configurations may reduce processing cycles, power consumption, and/or timing issues for the host processor.

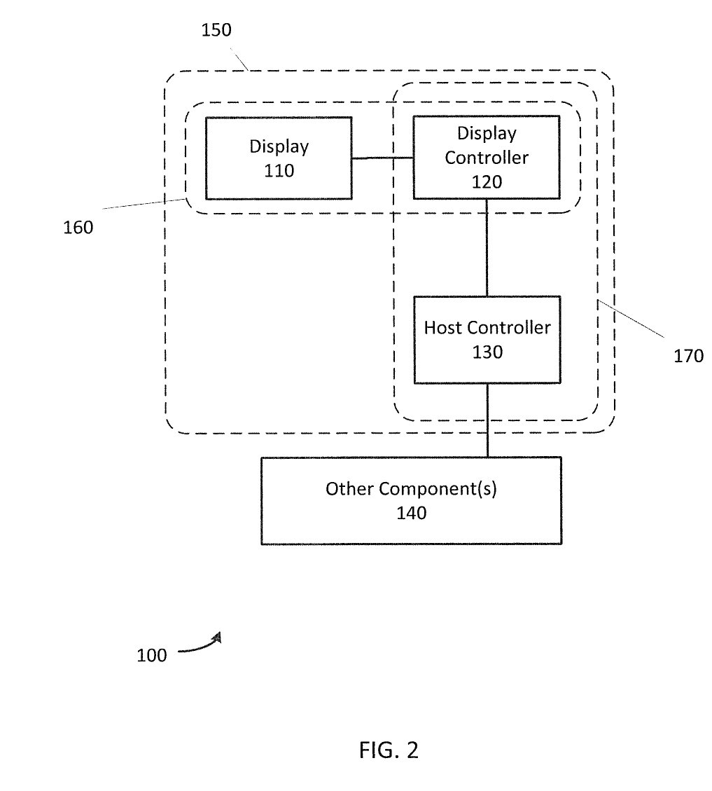

FIG. 2 illustrates an example electronic device 100 having a host controller 130, a display controller 120 and a display 110. The term electronic device can, in some examples, refer to one or more system(s) on chip (SoC), component(s) on a motherboard, discrete or integrated circuit(s), printed circuit board(s) (PCB), processor(s) or controller(s), memory module(s), display device(s), system(s), mobile device(s), electronic device(s), consumer electronic(s) or any combination thereof.

The display 110 can be any type of display device such as, for example, a liquid crystal display (LCD), a light-emitting diode (LED) display such as an organic light-emitting diode (OLED), an electronic paper display, a digital light processing (DLP) display, liquid crystal on silicon (LCOS) display, or any other suitable type of display.

The display device can be a small display and, in some examples, can have viewable area dimensions in the millimeter or centimeter range. For example, the display device can be a microdisplay such as an OLED microdisplay. In some examples, the microdisplay can include one or more magnifying or projecting elements for optically increasing the viewing area of the microdisplay.

In some examples, the display 110 may have a low resolution such as 20×20 pixels, 50×50 pixels or 100×100 pixels. A display 110 with a low resolution can require less power, less processing and/or a smaller frame buffer. For example, a 20×20 pixel display capable of displaying 24-bit color may only require 1.2 kilobytes of memory to store a single frame of data.

In other examples, the display 110 may be capable of displaying common resolutions such as 160×120, 240×160, 320×240, 640×480, 800×480, 800×600, 1024×768, 1280×720, 1280×1024, 1920×1080, and the like.

The display 110 can be capable of different colour depths. Example color depths can include 8-bit, 15-bit, 16-bit, 18-bit, 24-bit, 30-bit, 36-bit or 48-bit color. Other depths or displays capable of displaying different encoding schemes can also be used.

As discussed herein or otherwise, the display resolution, colour depth, and/or type of display technology can, in some examples, be selected based on desired output, low power considerations, memory requirements, processing requirements or any combination thereof. In general, lower resolutions and fewer colour bits can require less power, processing and memory.

The display controller 120 can include a microcontroller, microprocessor, logic circuit, and/or any other discrete or integrated components or circuitry suitable for controlling the display 110.

In some examples, the display controller 120 can include one or more frame buffers for storing one or more images or a multi-frame animation. The frame buffer(s) can include any physical memory such as EEPROM (electrically erasable programmable read-only memory, flash memory, RAM (random access memory), non-volatile RAM, registers, or any other suitable memory module or device.

The frame buffer(s) can, in some examples, be physically separate devices, or may be logical partitions in a multi-purpose or dedicated memory, or may be part of an integrated circuit or other electronic device such as the display 110, display controller 120, host controller 130, or other device.

In some examples, different frame buffers may be logically or physically part of different devices. For example, the display 110 may include a single frame buffer for buffering a frame currently being displayed on the display 110, while the display controller 120 may include or access additional frame buffer(s) storing frames of an animation or series of images.

The buffer(s) can be sized or otherwise configured to correspond to the resolution and colour/bit depth of the display 110. For example, the frame buffer(s) can be configured and/or sized to store the amount of data required to display a full-frame image on the display 110. In some examples, the frame buffer(s) can be configured and/or sized to store multiples of the amount of data required to display a full-frame image on the display 110.

For example, for a display having a 20×20 pixel resolution with 24-bit colour, the frame buffer(s) can be configured to store multiples of 1.2 kB of data. The number of multiples can affect the maximum number of frames in the buffer. In this example, the frame buffer(s) for storing a maximum of 10 image frames could be configured to store at least 12 kB of data.

As described herein, the display controller 120 can include control logic to control operation of the display 110 in response to signals or commands generated by or received from the host controller 130. In some examples, upon detection of a signal representing a command from the host controller 130 to display an animation, the display controller 120 can instruct or otherwise control the display 110 to commence and continue displaying the animation independent of and without requiring any additional signals or commands from the host controller 130.

The display controller 120 can, in some examples, have lower processing capabilities and/or utilize less power than the host controller 130.

The control logic can include executable instructions in the form of machine code, assembly code, firmware, software code, programmable gate arrays, circuit logic, or any other suitable form or any combination thereof.

In some examples, the display 110 and display controller 120 can be logically or physically considered to be a single electronic device such as a small display system 160. The small display system 160 can, in some examples, include various separate components including the display 110 and the display controller 120. The display controller 120 can be connected to the display 110 using vias, busses, wires, parallel or serial connections, or any other connection for exchanging data and/or command signals.

In some examples, the small display system 160 can be a single SoC, PCB or other electronic device which incorporates both the display 110 and the display controller 120.

The host controller 130 can include one or more processors or any computing device and can be configured to exchange or generate signals representing commands, inputs, outputs, and/or data for the display controller 120 and any other component(s) 140 in the electronic device 100.

In some examples, the host controller 130 can be configured to generate or send signals to cause the display controller 120 to commence or stop displaying an animation, or to transfer animation or image/frame data to the display controller 120 or otherwise to edit the image(s) or animation(s) stored in the frame buffer(s) for displaying on the display 110.

While the display 110, display controller 120 and host controller 130 are illustrated in the example electronic device 100 as separate blocks, these aspects can, in some examples, be in different physical or logical arrangements. In some examples, components such as memory(ies), registers, bus(ses), computing device(s), or any other modules can be shared between the separate blocks. In some examples, the host controller 130 and the display controller 120 can be a single logical or physical electronic device and may be referred to as the control system 170. In some examples, the display 110, display controller 120, and host controller 130 can be a single logical or physical electronic device and may be referred to as the display system 150. Other component(s) 140 or otherwise may be included in any one or more of these electronic devices.

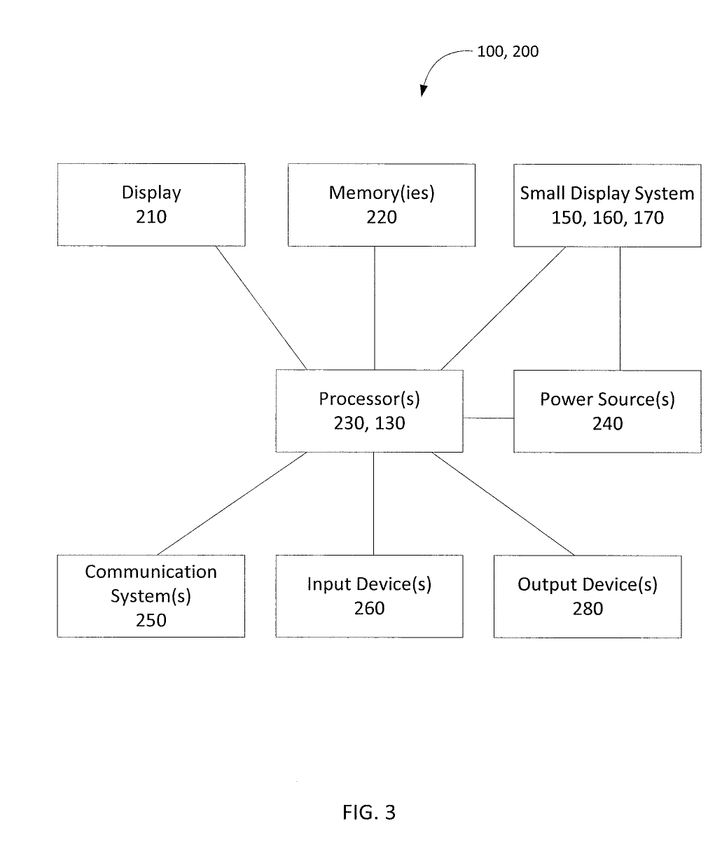

FIG. 3 illustrates an example electronic communication device 200 such as a mobile phone, tablet computer, laptop computer or the like. The electronic device 200 can include one or more processor(s) 230, 130 which can, in some examples, be connected to a primary display 210, memory(ies) 220, a small display system 150, 160, 170, power source(s) 240, communication system(s) 250, input device(s) 260, output device(s) 280 or any combination or subset thereof.

Memories 220 can include one or more RAMs (random access memory/ies), ROMs (read only memory/ies), EEPROMs (electrically erasable programmable read-only memory/ies), registers, flash memories, removable memories, hard drives, solid state disks, or any other memories suitable for storing computer-readable instructions/software modules or data. Communication system(s) 250 may include transmitters, receivers, digital signal or other processors, antennas, memories, RF (radio frequency) or other wireless communication circuitry, communications modules or any other components for establishing communications with the device. Example communications systems can include systems for communicating over Wi-Fi, Bluetooth, Ethernet, cellular networks, infrared, USB, NFC or any other suitable wired or wireless communication means. Input devices 260 can include, for example, keypads, touchpads, mice, keyboards, microphones, accelerometers, imaging devices, touchscreens, proximity sensors, GPS, QR/barcode or RFID scanners, card readers and the like. Output devices 280 can include, for example, speakers, lights, buzzers, and the like.

The power source(s) 240 can include one or more batteries or connections/circuitry for receiving wired or wireless (e.g. induction) power. In some examples, the small display system 150, 160, 170 can be independently connected to at least one power source 240 so it can be powered irrespective of the state of the processor(s) 230, 130.

In some examples, the small display system 150, 160, 170 may operate asynchronously, with its own clock, or otherwise independently from any clock/timing signals from the processor(s) 230, 130.

Software modules stored in one or more memories 220 or otherwise, can include computer-readable code which can be executed by the processor(s) 230, 130 to provide overall operation of the device and its components. Software modules can be in any form, can be organized in any manner, and can include, for example, operating systems, applications, communication modules, security modules, firmware, or modules for handling inputs, outputs or any other device component.

The processor(s) 230, 130 can be configured by the software modules or otherwise to perform/enable any aspect of the methods, systems and devices described herein. In some examples, the software or other modules can include modules for handling and/or providing notifications for email, SMS (short message service), social network, or any other type of messages. The software or other modules can, in some examples, include modules for handling and/or providing device status changes or alerts, alarms, input notifications, or any other type of update or notification.

In some examples, the device 100, 200 can be configured to operate and/or transition between different states or modes such as a high-power mode and a lower-power mode. High-power mode can, in some examples, refer to a high performance or normal mode of operation wherein, for example, the processor operates at a higher clock speed and/or when available, utilizes additional processor cores; the memory/ies can be access or written as normal or at higher rates faster; inputs and device or other statuses are monitored at a normal or higher rate; and/or the device otherwise utilizes more power relative to operation in the lower-power mode. Conversely, low-power mode can refer to a mode or state wherein the device 100, 200 utilizes less power than operation in the high-power mode. For example, low-power mode can refer to a sleep mode, hibernation mode, standby mode, or any other mode or state wherein the device operates at lower performance levels or otherwise utilizes less power than operation in the high-power mode.

In low-power mode, any number of components 140, 210, 220, 230, 130, 250, 260, 280 can be off or operate in a lower-power state. For example, the processor(s) 230, 130 may be off or may operate at a lower clock speed, lower voltage, utilizing a fewer number of cores, or in any other operation state which generally utilizes less power. In some situations, low-power mode may include turning off the primary display 210, reducing memory access or access speeds, reducing the frequency of monitoring or processing inputs from input device(s) 260, applications, communication system(s) 250, power source(s) 240, or any other device event or status change.

In some examples, the device 100, 200 may transition from a high-power mode to a low-power mode when an input is received, for example, activation of a power button or an input is received selecting a low-power mode from a menu. In some examples, the device 100, 200 may transition from a high-power mode to a low-power mode when a period of inactivity is detected.

The device 100, 200 may, in some examples, transition from a low-power mode to a high-power mode when an input device input, event, notification, message, device status change or other input or message is received.

Other examples of high-power modes, low-power modes, and triggers for transitioning between these modes can also be used.

In some examples, while operating in a high-power mode, the processor(s) 230, 130 can be configured to be active and to interact with the display controller 120. In a high-power mode, the processor(s) 230, 130 can be configured to send or generate signals representing instructions and/or data to the display controller 120/small display system 150, 160, 170.

In some examples, while operating in a low-power mode, the processor(s) 230, 140 can be configured to be passive with respect to the display controller 120 such that they do not send, generate signals or otherwise interact with the display controller 120/small display system 150, 160, 170.

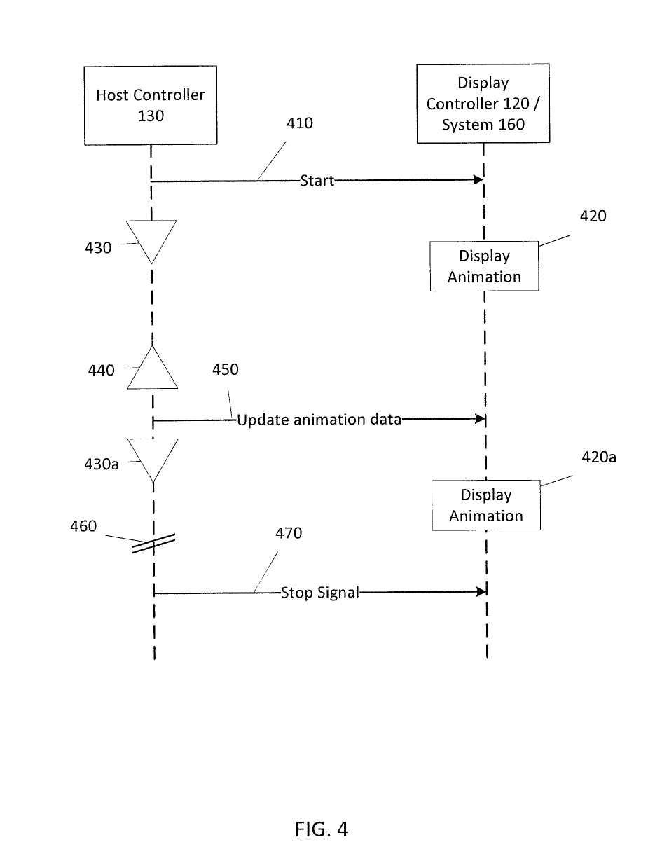

FIG. 4 shows a flow diagram including events which by way of example illustrate interactions between the host controller 130 and the display controller 120.

At 410, the host controller 130, in a high-power state or otherwise, can generate signals representing a start command for the display controller 120. The host controller 130 can, in some examples, send the signals to the display controller 120, or write the signals representing the start command to a register or memory element at or accessible by the display controller 120.

The display controller 120 can be configured to detect the signals representing the start command. In one example, the receipt of signals representing the start command sent by the display controller may trigger an interrupt for handling the start command. In another example, the display controller 120 may be configured detect a signal by polling or monitoring a register or memory element to which signals representing the start command can be written.

At 420, upon detection of the signals representing the start command, the display controller 120 can generate signals for causing the display 110 to display the animation on the display 110. The signals may include, for example, signals for reading frame data from the buffer(s), and sending the frame information to the display in the appropriate format and timing, along with any sync or timing signals if necessary.

The display controller 120 can continue to generate signals for causing the display 110 to repeatedly display the animation indefinitely or for a predefined period time without any further command from or interaction with the host controller 130. This repeated display of the animation can continue irrespective of any other activity of change of state/mode at the host controller 130.

For example, after generating the signals representing the start command at 410, the host controller 130 can, at 430, enter a low-power mode such as a sleep mode. At 440, the host controller 130 may transition from the low-power mode to a high-power mode upon detecting an trigger or event such as receipt of a message.

After the display controller 120 begins displaying the animation at 420 in response to detecting the signals representing the start command from the host controller 130, the display controller 120 can operate independently from the host controller 130, and can be unaware of any activities or changes of state or mode at the host controller 130. In the absence of detecting any further signals from the host controller, the display controller 120 continues to generate signals to repeatedly display 420 the animation on the display 110 even while the host controller 130 transitions into a low-power mode at 430 and back into a high-power mode at 440.

In some examples, the autonomous display of the animation by the display controller 120 can reduce the processing cycles traditionally required for the host controller 130 to directly control and maintain animation on the display 110. In some examples, the relative independence of the display controller 120 may reduce power by allowing the host controller 130 to enter a low-power mode while the display controller 120 continues to display an animation. Further power savings can, in some examples, be obtained by using a low power display 110 such as a microdisplay and/or using a display having a relatively low resolution and/or colour depth.

In another example scenario, the host controller 130, at 450, can generate signals to update at least a portion of the animation data stored at the display controller 120. For example, the signals may include a subset of the animation data such as a frame or series of frames in the animation, or data representing an entire animation. Depending on the command signals generated, the new animation data can be appended to or overwrite existing animation data stored at the display controller 120. In some examples, the host controller 130 can generate signals to delete or remove a subset of or an entire animation from the display buffer(s).

In some examples, the host controller 130 may send new or updated animation data to the display controller 120 which then stores the new or updated animation data in the display buffer(s). In other examples, the host controller 130 may be able to access and write to the display buffer(s) directly without direct interaction with the display controller 120.

Upon the updating of the animation data in the display buffer(s), the display controller 120 can be configured to continue generating 420a signals for displaying the animation on the display 110. In some examples, this can continue until the host controller 130 generates, at 470, signals representing a command to stop displaying the animation. Upon detection of the signals representing the stop command, the display controller 120 can terminate display of the animation by generating signals for the display 110 to stop displaying the animation, or by ending the generation of signals for displaying the animation on the display 110.

The detection of signals representing commands to stop displaying the animation or to update the animation data can, in some examples, be similar to the detection of the signals representing the start command as described herein.

While the display controller 120 is generating signals to display the animation at 420a, the host controller 130 can be free to enter a low power mode (e.g. at 430a) and any other intervening events and/or activities can occur at the host controller (e.g. at 460).

In some examples, an animation can include one or more related or unrelated frames. For example, an animation can include a sequence of related frames which when displayed in order can appear to display motion or a gradual change in appearance. Unrelated frames can, for example, be used to display unrelated notifications.

The display controller 120 can be configured to display the animation frames in rapid succession or with pauses in between each frame. In some examples, animation frame(s) can be flashed by alternating periods during which a frame is displayed with periods during which the display is off or is displaying black.

The display controller 120 can, in some examples, be configured to display the animation by indexing or cycling through the different frames in the buffer. In some examples, the display controller 120 can be configured to display only selected frames in the display buffer, or to display selected frames for a longer duration than other frames in the display buffer. In some examples, these options for displaying the animation can be generated by the host controller 130 as part of the signals representing the start or update animation commands.

In some examples, the animation frames can be used to display notifications or display text or information related to a message or event. For example, if a new email message and a new social network update are received by the device 100, 200. The display controller 120 can be configured to store and display an animation cycling between an icon representing an email application, and an icon representing the social network.

In some examples, images may be pre-stored in the display buffer(s). For example, in the scenario above, an email, a social networking, and a low battery icon may be stored on the display buffer(s) before any message or event occurs. When the new email and social networking messages arrive, the signals representing the start command from the host controller 130 can include a command to display the frames corresponding to the email icon and the social networking icon.

With reference again to FIG. 4, in another example scenario, the device 100, 200 is in a power saving state with the primary display 210 off, and the host controller 130 in a low power state at 430. If a new message is received from the recipient's wife, the new message can at 440 trigger the host controller 130 to wake up from the low power mode to a high power mode; generate signals, at 450, representing instructions to update the animation data; and at 430a immediately return the host controller 130 to a lower power mode.

In some examples, the animation frames can display data or information regarding the message. For example, in the previous example, the animation may display the word “wife” statically or scrolling across the display.

Any other animations or dynamic use of the display 110 for text or images can also be used.

In further aspects, the disclosure provides systems, devices, methods, and computer programming products, including non-transient machine-readable instruction sets, for use in implementing such methods and enabling control of mobile and other communication and computing devices.

Although the disclosure has been described and illustrated in exemplary forms with a certain degree of particularity, it is noted that the description and illustrations have been made by way of example only. Numerous changes in the details of construction and combination and arrangement of parts and steps may be made. Accordingly, such changes are intended to be included in the invention, the scope of which is defined by the claims.

Except to the extent explicitly stated or inherent within the processes described, including any optional steps or components thereof, no required order, sequence, or combination is intended or implied. As will be will be understood by those skilled in the relevant arts, with respect to both processes and any systems, devices, etc., described herein, a wide range of variations is possible, and even advantageous, in various circumstances, without departing from the scope of the invention, which is to be limited only by the claims.

What is claimed is:

1. An electronic device comprising:
a microdisplay; and
a display controller for the microdisplay, the display controller comprising:
at least one frame buffer configured to store a multi-frame animation; and
control logic configured to control operation of the microdisplay in response to signals generated by a host controller of the mobile electronic device, the control logic comprising executable instructions to display the animation on the microdisplay by:
commencing display of the animation when signals representing a start command generated by the host controller are detected, and
repeatedly displaying the animation in the absence of detecting further signals representing commands generated by the host controller.

2. The electronic device of claim 1, wherein the host controller is configured to generate the signals representing the start command when operating in a high-power mode of operation.

3. The electronic device of claim 2, wherein the host controller is configured to generate the signals representing the start command after transitioning to the high-power mode of operation following operation for a period in a low-power mode of operation.

4. The electronic device of claim 2, wherein repeatedly displaying the animation continues when the host controller transitions from the high-power mode to a low-power mode of operation.

5. The electronic device of claim 1, wherein the host controller is further configured to transmit at least a portion of the multi-frame animation to the display controller for storage in at least one of the at least one frame buffer.

6. The electronic device of claim 1, wherein the control logic further comprises instructions to terminate display of the animation when signals representing a stop command instructing display of the animation to terminate are detected.

7. The electronic device of claim 6, wherein the host controller is configured to transmit the stop command to the display controller when operating in the high-power mode of operation.

8. The electronic device of claim 7, wherein the host controller is configured to transmit the stop command to the display controller after transitioning back to the high-power mode of operation following operation for a period in the low-power mode of operation.

9. The electronic device of claim 3, wherein the host controller is configured to transition back to the low-power mode of operation following generation of the signals representing the start command.

10. The electronic device of claim 1, wherein the display controller is configured to detect signals representing commands generated by the host controller by polling a register storing the signals, or by generating an interrupt upon receipt of the signals.

11. A computer readable medium persistently storing control logic configured to control operation of a microdisplay of a mobile electronic device in response to commands from a host controller of the mobile electronic device, the control logic comprising executable instructions to display a multi-frame animation on the microdisplay by:
commencing display of the animation when signals representing a start command generated by the host controller are detected, and
repeatedly displaying the animation in the absence of detecting further signals representing commands generated by the host controller.

12. The computer readable medium of claim 11, wherein repeatedly displaying the animation continues when the host controller transitions from a high-power mode to a low-power mode of operation.

13. The computer readable medium of claim 11, wherein the control logic further comprises instructions for receiving at least a portion of the multi-frame animation from the host controller for storage in at least one of the at least one frame buffer.

14. The computer readable medium of claim 11, wherein the control logic further comprises instructions for terminating display of the animation when signals representing a stop command instructing display of the animation to terminate are detected.

15. The computer readable medium of claim 11, wherein the control logic further comprises instructions for detecting signals representing commands generated by the host controller by polling a register storing the signals, or by generating an interrupt upon receipt of the signals.

16. A display controller for a microdisplay of an electronic device, the display controller comprising:
at least one frame buffer configured to store a multi-frame animation; and
control logic configured to control operation of the microdisplay in response to signals generated by a host controller of the electronic device, the control logic comprising executable instructions to display the animation on the microdisplay by:
commencing display of the animation when signals representing a start command generated by the host controller are detected, and
repeatedly displaying the animation in the absence of detecting further signals representing commands generated by the host controller.

17. The display controller of claim 16, wherein repeatedly displaying the animation continues when the host controller transitions from a high-power mode to a low-power mode of operation.

18. The display controller of claim 16, wherein the control logic further comprises instructions for receiving at least a portion of the multi-frame animation from the host controller for storage in at least one of the at least one frame buffer.

19. The display controller of claim 16, wherein the control logic further comprises instructions for terminating display of the animation when signals representing a stop command instructing display of the animation to terminate are detected.

20. The display controller of claim 16, wherein the control logic further comprises instructions for detecting signals representing commands generated by the host controller by polling a register storing the signals, or by generating an interrupt upon receipt of the signals.
